(19) United States
(12) Patent Application Publication
(10) Pub. No.: US 2024/0133355 A1
(43) Pub. Date: Apr. 25, 2024

(54) FUEL INJECTOR NOZZLE AND MANUFACTURING METHOD FOR THE SAME

(71) Applicant: Cummins Inc., Columbus, IN (US)

(72) Inventors: Romaine O. Edwards, Greenwood, IN (US); Frank Husmeier, Columbus, IN (US); Darin Bartholomew, Columbus, IN (US); Manoj M. Thete, Greenwood, IN (US)

(21) Appl. No.: 18/476,544

(22) Filed: Sep. 27, 2023

(30) Foreign Application Priority Data
Oct. 19, 2022 (CN) 202211286537.X

(51) Int. Cl. F02M 61/18

(52) U.S. Cl. CPC F02M 61/18; F02M 2200/02; F02M 2200/9046; F02M 2200/9061

(57) ABSTRACT

A fuel injector and a nozzle for a fuel injector is provided. The nozzle includes at least one spray hole that is formed through a hardened nozzle body. The nozzle body is hardened again after forming the at least one spray hole to hardened the nozzle body along the at least one spray hole.

### CROSS-REFERENCE TO RELATED APPLICATIONS

The present application claims the benefit of the filing date of Chinese Patent Application No. 202211286537.X filed on Oct. 20, 2022, which is incorporated herein by reference in its entirety for all purposes.

### FIELD OF THE DISCLOSURE

The present disclosure relates generally to a fuel injection system for an internal combustion engine and, more particularly, to fuel injector nozzles and manufacturing methods for the same.

### BACKGROUND

Some fuel injectors include one or more spray holes extending through the nozzle of the fuel injector. The spray holes are subject to high mechanical loads and stress during the fuel injection process. As a result, cavitation and erosion in the material along the spray hole can change the injection form and the amount of fuel that passes through the spray hole. These changes can result in difficulties in meeting emissions limits and may cause engine damage. Therefore, the fuel injector nozzles must be replaced at appropriate intervals. While various attempts have been made at improving the durability of the nozzle spray holes, there remains a need for further improvements such as those disclosed herein.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific terminology will be used to describe the same. It shall nevertheless be understood that no limitation of the scope of the invention is thereby created and that the invention includes and protects such alterations, modifications, and further applications of the exemplary embodiments as would occur to one skilled in the art.

### SUMMARY

The present disclosure includes a unique nozzle for a fuel injector and fuel injection system for an internal combustion engine. The nozzle includes at least one spray hole for spraying fuel from the fuel injector. The spray hole includes a layer of material along the spray hole that improves wear-resistance of the at least one spray hole, improving fuel injector performance and longevity.

In an embodiment, there is illustrated a nozzle for a fuel injector is provided. The nozzle includes an elongated body extending along a longitudinal axis from a first end of the elongated body to an opposite second end of the elongated body. The elongated body includes a longitudinally extending fuel passage extending from the first end of the elongated body to the second end of the elongated body. Elongated body also includes at least one spray hole at the second end of the elongated body. The at least one spray hole is defined by a hard wear resistant layer on the elongated body that extends along the spray hole.

A method for producing a fuel inject nozzle is disclosed. Method includes an operation or step to harden a nozzle body, an operation or step to form at least one spray hole through the hardened nozzle body, and an operation or step to re-harden the nozzle body after forming the at least one spray hole to form a hard wear resistant layer of material through the hardened nozzle body along the at least one spray hole.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic view of a fuel injector according to an embodiment of the present disclosure.

FIG. 2 is a sectional view illustrating certain aspects of a nozzle for a fuel injector, according to an embodiment of the present disclosure.

FIG. 3 is a flow diagram of a procedure for producing a nozzle for a fuel injector, according to an embodiment of the present disclosure.

### DETAILED DESCRIPTION OF ILLUSTRATIVE EMBODIMENTS

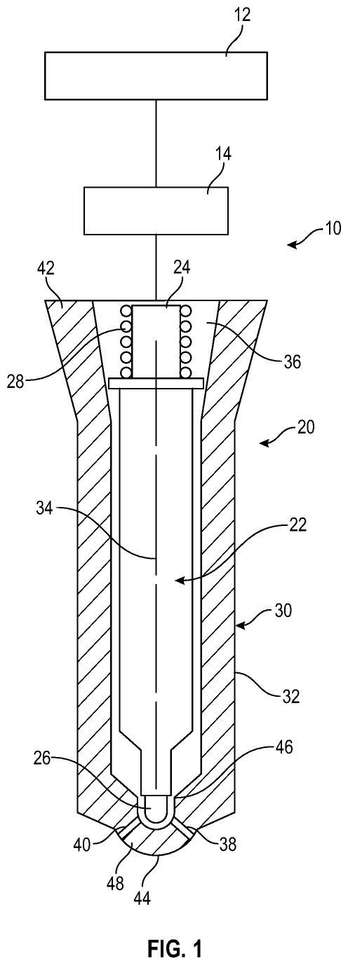

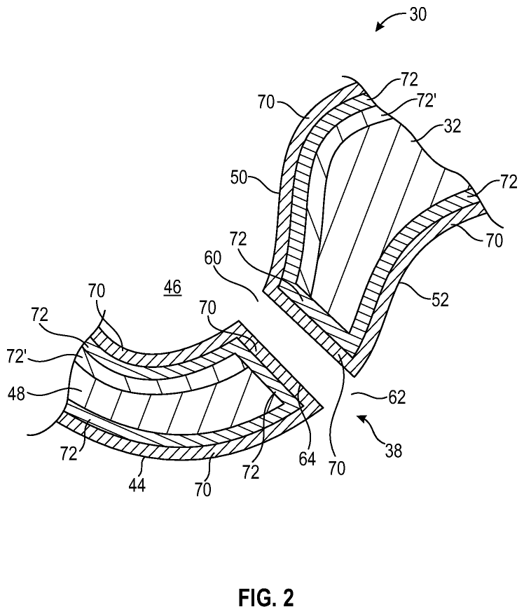

With reference to FIGS. 1-2, there is illustrated a nozzle 30 for a fuel injector 20. The nozzle 20 includes an elongated body 32 extending along a longitudinal axis 34 from a first end 42 of the elongated body to an opposite second end 44 of the elongated body 32. The elongated body 32 includes a longitudinally extending fuel passage 36 extending from the first end 42 of the elongated body 32 to the second end 44 of the elongated body 32. Elongated body 32 also includes at least one spray hole 38, 40 at the second end 44 of the elongated body 32. The at least one spray hole 38, 40 is defined by a hard wear resistant layer 70 on the elongated body 32 that extends along the spray hole 38, 40.

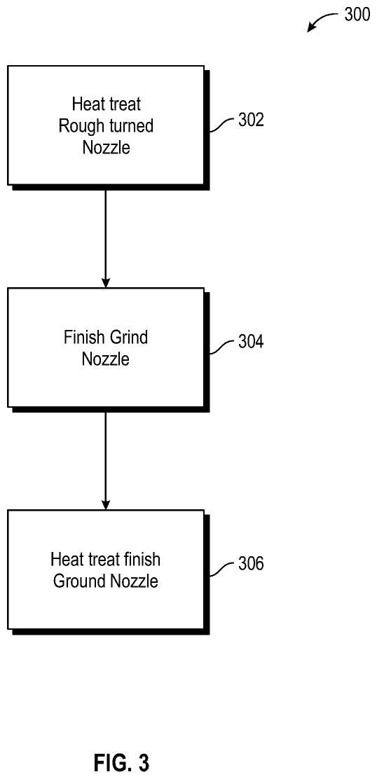

With further reference to FIG. 3, a method 300 for producing a fuel inject nozzle 30 is disclosed. Method 300 includes an operation or step 302 to harden a nozzle body 32, an operation or step 304 to form at least one spray hole 38, 40 through the hardened nozzle body 32, and an operation or step 306 to re-harden the nozzle body 32 after forming the at least one spray hole 38, 40 to form a hard wear resistant layer 70 of material through the hardened nozzle body 32 along the at least one spray hole 38, 40.

Referring to FIG. 1, a fuel injector system 10 includes an accumulator 12 connected to a fuel injector 20 with connection components 14. Accumulator 12 may be, for example, part of a high pressure common rail fuel injector system. Connection components 14 may include, for example, valves, throttles, control chambers, tubing, and other components that may be typically provided to connect a fuel injector 20 to an accumulator 12.

Fuel injector 20 includes a nozzle 30 that houses a needle 22. Nozzle 30 includes an elongated body 32 that extends along a central longitudinal axis 34. Body 32 includes a fuel passage 36 that receives needle 22 therein. The needle 22 is elongated and extends between a proximal end 24 and a distal end 26 of needle 22. The needle 22 moves up and down longitudinally in the fuel passage 36 to selectively start and stop fuel injection from the fuel passage 36 through one or more spray holes 38, 40 of nozzle 30.

Although only two spray holes 38, 40 are shown, embodiments are contemplated with just one spray hole, or with three or more spray holes. In addition, the spray holes 38, 40 may be arranged in any patterns on nozzle 30. In the illustrated embodiment, spray holes 38, 40 are circular and include a uniform diameter from inlet to outlet. However, non-circular spray holes, and spray holes with non-uniform dimension along the axial length there are also contemplated.

Nozzle 30 includes a proximally oriented first end 42 and an opposite distally oriented second end 44. Fuel passage 36 forms a sac 46 in a nozzle seat 48 located at second end 44 of body 32. Spray holes 38, 40 extend through body 32 at seat 48. The distal end 26 of the needle 22 is moved into and out of engagement with nozzle seat 48 in sac 46 to selectively close and open spray holes 38, 40 for injection of fuel.

For example, during a fuel injection event, a closing force is removed from needle 22 to allow needle 22 to be lifted off the nozzle seat 48 so that fuel is injected from sac 46 into an engine cylinder (not shown) through spray holes 38, 40. A needle spring 28 surrounding a portion of the needle 22 may be provided in the fuel passage 36 to assist in controlling longitudinal movement of the needle 22.

Further details of the spray holes 38, 40 will now be discussed with reference to FIG. 2 and spray hole 38, it being understood that such details may also apply to any other spray holes provided with nozzle 30. Spray hole 38 includes an inlet 60 opening at an inner surface 50 of body 32 at sac 46. Spray hole 38 opens at an outlet 62 on an outer surface 52 of body 32 adjacent to second end 44. Spray hole 38 is defined by a surface 64 of body 32 that extends around spray hole 38, and surface 64 extends from inlet 60 to outlet 62.

In an embodiment, surface 64 is formed by a hard wear resistant layer 70 of material that is created by hardening of nozzle body 32 after formation of the spray holes 38, 40, such as via an electric discharge machining (EDM) process. In an embodiment, the hard wear resistant layer is a material layer that appears white when viewed in ground, polished, and etched condition at magnification exceeding 100×.

Other embodiments contemplate other techniques for forming the spray holes 38, 40, such as electrochemical machining, laser drilling, etc. Preferably, nozzle body 32 is also hardened prior to forming spray hole 38, such that the formation of the hard wear resistant layer 70 occurs during a second hardening of nozzle 30 after spray hole 38 is formed in a previously hardened nozzle body 32.

The hardening of nozzle body 32 creates a diffusion layer 72 between hard wear resistant layer 70 and a substrate 74. In an embodiment, substrate 74 is the original core material of nozzle body 32 before it is hardened. The core material for substrate 74 can be any material suitable for a fuel injector nozzle, including any suitable metal and/or metal alloys, for example.

In an embodiment, the first and second hardening of nozzle body 32 are completed using first and second gas nitriding processes. The second nitriding process is designed to produce a uniform compound layer, which includes the hard wear resistant layer 70 along with a porous layer overlying the hard wear resistant layer 70, and a diffusion layer 72 between the hard wear resistant layer and the substrate 74.

Hard wear resistant layer 70 includes iron nitrides. In an embodiment, hard wear resistant layer 70 consists essentially of, or consists of, iron nitrides. Diffusion layer 72 includes a nitrogen enriched martensitic matrix. In an embodiment, diffusion layer 72 consists essentially of, or consists of, a nitrogen enriched martensitic matrix.

In an embodiment, porosity from the porous layer overlying the hard wear resistant layer 70 that is formed by the second nitriding process is removed after the second nitriding process by an abrasive flow machining process. The abrasive flow machining process is controlled so as to preserve the hard wear resistant layer 70 while removing the porous layer. In addition, the thickness of the diffusion layer 72 created in the second nitriding process is limited to about half of the thickness of the diffusion layer 72′ formed during the first nitriding process, avoiding excessive precipitation of nitrides along the grain boundaries to prevent the surface from becoming excessively brittle.

In an embodiment, the second nitriding process is designed to limit the thickness of the hard wear resistant layer 70 below 15 microns upon completion of the abrasive flow machining process. In an embodiment, the hard wear resistant layer 70 consists essentially of gamma-prime (γ′-Fe4N) and epsilon (ε-Fe2-3N) iron nitrides, and is free of excessive porosity after abrasive flow machining. In an embodiment, the hard wear resistant layer 70 lacks surface porosity after abrasive flow machining.

In an embodiment, the diffusion layer 72′ includes a first thickness, and diffusion layer 72 includes a second thickness along the at least one spray hole 38 measured from spray hole surface 64. In an embodiment, the second thickness is less than the first thickness.

The spray hole 38 is provided with enhanced mechanical and chemical properties due to forming spray hole 38 in a hardened material and then performing the second nitriding process after forming the spray hole 38. For example, spray hole 38 has improved wear and corrosion performance characteristics over nozzles formed via single stage nitriding processes. The first nitride process in the present disclosure forms a very hard outer “shell” layer on nozzle body 32 that has compressive residual stress. When the spray hole 38 is formed, the hole-forming tool compresses this hard nitride layer and the inlet 60 of the spray hole 38 becomes compressive, making the spray hole 38 very robust against wear and fatigue. The second nitriding process is then used to create a hard wear resistant layer along spray hole 38 from inlet 60 to outlet 62.

A method 300 is illustrated in FIG. 3 for producing a fuel injector nozzle according to the present disclosure. Method 300 includes an operation 302 to harden a rough-turned nozzle body 32. The rough-turned nozzle body 32 may be machined from a solid soft blank of core material that will eventually form the substrate 74. The rough turned nozzle 30 may include soft machining to form the external shape and internal shape of nozzle 30, such as fuel passage 36. However, spray holes 38, 40 are not yet formed in the rough-turned nozzle body 32. The rough-turned nozzle body 32 may be washed before the hardening treatment. The hardening treatment of the rough-turned nozzle body 32 can be, for example, a gas nitriding process, to enhance surface hardness to a particular depth to aid in subsequent machining. This first hardening treatment forms a hard wear resistant layer and diffusion layer on the exposed surfaces of the rough-turned nozzle body 32.

Method 300 continues at operation 304 to finish grind the hardened rough-turned nozzle body 32. Operation 304 may also include further rough-turning of the hardened nozzle body 32 if necessary. The inner and outer surfaces of nozzle body 21 can then be finish ground, and washed and/or demagnetized. The spray hole locations are laser marked, and spray holes 38, 40 are now formed in the nozzle body 30 using any suitable hole forming device and/or technique, as discussed above. The hole formation in the hardened material provides a compressive residual stress at the inlet of the spray holes 38, 40, such as at inlet 60 of spray hole 38.

Method 300 continues at operation 306 to re-harden the nozzle 30 after formation of spray holes 38, 40. Nozzle 30 may be washed before re-hardening. This second hardening treatment provides a hardening along the axial length of spray holes 38, 40 from the inlet to the outlet thereof. As discuss above, this hardening is provided by hard wear resistant layer 70 extending from the inlet to the outlet of the spray holes. In addition, the hard wear resistant layer 70 may extend outwardly from the inlet 60 of spray holes 38, 40 along the inner surface 50 of sac 44. Hard wear resistant layer 70 may also extend outwardly from the outlet 62 of spray holes 38, 40 along the outer surface 52 of nozzle body 32. After re-hardening, the nozzle 30 may be washed and laser marked.

Method 300 may include a further operation to abrasive flow machine the nozzle 30 including spray holes 38, 40 after the second hardening treatment. The abrasive flow machining can be controlled so that only the porous layer or porous material created from the second hardening treatment is removed from the hard wear resistant layer 70. However, the hard wear resistant layer 70 remains along the exposed surfaces of the spray holes 38, 40.

Further written description of a number of aspects of the present disclosure shall now be provided. According to one aspect, a nozzle for a fuel injector is provided. The nozzle includes an elongated body extending along a longitudinal axis from a first end of the elongated body to an opposite second end of the elongated body. The elongated body includes longitudinally extending fuel passage extending from the first end of the elongated body to the second end of the elongated body. The elongated body also includes at least one spray hole at the second end of the elongated body. The at least one spray hole is defined by a hard wear resistant layer on the elongated body that extends along the spray hole.

In an embodiment of the nozzle, the hard wear resistant layer extends from the fuel passage through the elongated body at the second end of the elongated body. In an embodiment of the nozzle, the at least one spray hole includes a plurality of spray holes, and each of the plurality of spray holes is defined by the hard wear resistant layer on the elongated body.

In an embodiment of the nozzle, the elongated body includes a substrate formed by a core material of the elongated body. a diffusion layer on the substrate, and the hard wear resistant layer on the hardened layer. In a refinement of this embodiment, the diffusion layer is a nitrogen enriched martensitic matrix.

In another refinement of the above embodiment, the diffusion layer includes a first diffusion layer along the fuel passage having a first thickness, and a second diffusion layer along the fuel passage and along the at least one spray hole having a second thickness, and the second thickness is less than the first thickness. In a further refinement, the second thickness is about half of the first thickness.

In an embodiment of the nozzle, the at least one spray hole extends from an inlet at the fuel passage to an outlet on an outer surface of the elongated body, and the hard wear resistant layer extends from the inlet to the outlet of the at least one spray hole. In a refinement of this embodiment, the hard wear resistant layer extends outwardly from the outlet of the at least one spray hole along the outer surface of the elongated body. In another refinement, the hard wear resistant layer extends outwardly from the inlet of the at least one spray hole along an inner surface of the elongated body.

In an embodiment of the nozzle, the hard wear resistant layer includes iron nitrides. In a refinement of this embodiment, the iron nitrides include gamma prime (Fe4N) and epsilon (Fe2-3N) iron nitrides.

In an embodiment of the nozzle, the hard wear resistant layer is less than 15 microns. In an embodiment of the nozzle, the hard wear resistant layer lacks surface porosity.

According to another aspect of the present disclosure, a method for producing a fuel injection nozzle is provided. The method includes a) hardening a nozzle body; b) forming at least one spray hole through the hardened nozzle body; and c) re-hardening the hardened nozzle body after forming the at least one spray hole to form a hard wear resistant layer of material through the hardened nozzle body along the at least one spray hole.

In an embodiment, the method includes machining the nozzle body along the spray hole to remove porous material from the hard wear resistant layer. In one refinement, machining the nozzle body includes abrasive flow machining the porous material from the hard wear resistant layer. In another refinement, the hard wear resistant layer is less than 15 microns after removing the porous material.

In an embodiment of the method, forming the least one spray hole includes electrical discharge machining the at least one spray hole through a hardened layer of the nozzle body. In a refinement of this embodiment, electrical discharge machining the least one spray hole includes compressing hardened material around an inlet of the at least one spray hole.

In an embodiment of the method, hardening the nozzle body in steps a) and c) includes subjecting the nozzle body to a diffusive heat process to form the hard wear resistant layer. In a refinement of this embodiment, the diffusive heat process is a gas nitriding process.

In an embodiment of the method, the nozzle body is rough-turned before step a) to form a fuel passage in the nozzle body, and the at least one spray hole formed in step b) extends from the fuel passage through the nozzle body to an exterior surface of the hardened body.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A nozzle for a fuel injector, the nozzle comprising:
an elongated body extending along a longitudinal axis from a first end of the elongated body to an opposite second end of the elongated body, the elongated body including:
a longitudinally extending fuel passage extending from the first end of the elongated body to the second end of the elongated body; and
at least one spray hole at the second end of the elongated body, the at least one spray hole being defined by a hard wear resistant layer on the elongated body that extends along the spray hole.

2. The nozzle of claim 1, wherein the hard wear resistant layer extends from the fuel passage through the elongated body at the second end of the elongated body.

3. The nozzle of claim 1, wherein the at least one spray hole includes a plurality of spray holes, and each of the plurality of spray holes is defined by the hard wear resistant layer on the elongated body.

4. The nozzle of claim 1, wherein the elongated body includes:
a substrate formed by a core material of the elongated body;
a diffusion layer on the substrate; and
the hard wear resistant layer on the hardened layer.

5. The nozzle of claim 4, wherein the diffusion layer is a nitrogen enriched martensitic matrix.

6. The nozzle of claim 4, wherein the diffusion layer includes a first diffusion layer along the fuel passage having a first thickness, and a second diffusion layer along the fuel passage and along the at least one spray hole having a second thickness, and the second thickness is less than the first thickness.

7. The nozzle of claim 6, wherein the second thickness is about half of the first thickness.

8. The nozzle of claim 1, wherein the at least one spray hole extends from an inlet at the fuel passage to an outlet on an outer surface of the elongated body, and the hard wear resistant layer extends from the inlet to the outlet of the at least one spray hole.

9. The nozzle of claim 8, wherein:
the hard wear resistant layer extends outwardly from the outlet of the at least one spray hole along the outer surface of the elongated body; and
the hard wear resistant layer extends outwardly from the inlet of the at least one spray hole along an inner surface of the elongated body.

10. The nozzle of claim 1, wherein the hard wear resistant layer includes iron nitrides, and wherein the iron nitrides include gamma prime (Fe4N) and epsilon (Fe2-3N) iron nitrides.

11. The nozzle of claim 1, wherein the hard wear resistant layer is less than 15 microns.

12. The nozzle of claim 1, wherein the hard wear resistant layer lacks surface porosity.

13. A method for producing a fuel injection nozzle, the method comprising:
a) hardening a nozzle body;
b) forming at least one spray hole through the hardened nozzle body; and
c) re-hardening the hardened nozzle body after forming the at least one spray hole to form a hard wear resistant layer of material through the hardened nozzle body along the at least one spray hole.

14. The method of claim 13, further comprising:
machining the nozzle body along the spray hole to remove porous material from the hard wear resistant layer.

15. The method of claim 14, wherein machining the nozzle body includes abrasive flow machining the porous material from the hard wear resistant layer.

16. The method of claim 14, wherein the hard wear resistant layer is less than 15 microns after removing the porous material.

17. The method of claim 13, wherein forming the least one spray hole includes electrical discharge machining the at least one spray hole through a hardened layer of the nozzle body.

18. The method of claim 17, wherein electrical discharge machining the least one spray hole includes compressing hardened material around an inlet of the at least one spray hole.

19. The method of claim 13, wherein hardening the nozzle body in steps a) and c) includes subjecting the nozzle body to a diffusive heat process to form the hard wear resistant layer, and wherein the diffusive heat process is a gas nitriding process.

20. The method of claim 13, wherein:
the nozzle body is rough-turned before step a) to form a fuel passage in the nozzle body; and
the at least one spray hole formed in step b) extends from the fuel passage through the nozzle body to an exterior surface of the hardened body.
